(19) United States
(12) Patent Application Publication
(10) Pub. No.: US 2024/0373135 A1
(43) Pub. Date: Nov. 7, 2024

(54) METHOD AND IMAGE PROCESSOR UNIT FOR PROCESSING DATA PROVIDED BY AN IMAGE SENSOR

(71) Applicant: Dream CHIP Technologies GmbH, Garbsen (DE)

(72) Inventors: Martin FIEDLER, Hannover (DE); Julian HARTIG, Langenhagen (DE); Christoph HEINRICHS, Hannover (DE)

(73) Assignee: Dream CHIP Technologies GmbH, Garbsen (DE)

(21) Appl. No.: 18/690,850

(22) PCT Filed: Jun. 24, 2022
(86) PCT No.: PCT/EP2022/067398

§ 371 Date: Mar. 11, 2024

(51) Int. Cl. H04N 23/81; H04N 23/84; H04N 25/13

(52) U.S. Cl. CPC H04N 23/81; H04N 23/84; H04N 25/135

(57) ABSTRACT

The invention discloses a method for processing of image data provided by an image sensor, wherein the image data comprises a frame formed by an array of pixels, said pixel array being overlaid with a colour filter array so that the pixels represent colour information according to a specific colour pattern defined by the colour filter array. The method includes the step of multiplying each pixel of the frame by a respective gain factor pre-defined in a stored gain matrix for a pixel position which corresponds to the pixel in the frame when the gain matrix is positioned on the frame, wherein the gain matrix is smaller than the frame and is placed in a plurality of different positions on the frame to multiply each pixel of the frame by a respective gain factor of the gain matrix.

### FIELD OF THE INVENTION

The invention relates to a method for processing image data provided by an image sensor, wherein the image data comprises a frame formed by an array of pixels, said pixel array being overlaid by a colour filter array so that the pixels represent colour information according to a specific colour pattern defined by the colour filter array.

The invention further relates to an image processor unit for processing image data provided by an image sensor, said image sensor comprising a sensor pixel array providing a frame formed by an array of pixels being overlaid by a colour filter array so that the pixels represent colour information according to a specific colour pattern defined by the colour filter array.

The invention further relates to a computer program comprising instructions to execute the steps of the aforementioned method.

### BACKGROUND OF THE INVENTION

The pixel array of a standard digital image sensor is designed to capture light without favouring any specific wave lengths. The resulting image is a monochromatic image without any colour information. To generate the colour information, the pixel array is overlaid by a colour filter array, which is a grid of optical filters for different wave lengths. The most common colour filter array pattern is the Bayer colour filter which consists of 2×2 basic cells containing one red (R), two green (G) and one blue (B) pixel cell points. A basic cell is repeated over the entire pixel array of the image sensor, generating an image with R, G and B pixels. Due to this process, the colour information is incomplete. The process of reconstructing the missing colour information, e.g. reconstructing R and G and B for every pixel, is known as demosaicing.

Other types of colour filter arrays exist, like Quad Bayer, HexaDeca or 6×6 colour filter array. Thus, advanced image sensors use complex colour filter array patterns, not just the 2×2 Bayer, but larger N×M RGB or RGBW colour filter arrays (W=white).

A problem of pixel crosstalk occurs in particular with increasing effect for higher order colour filter array patterns. Crosstalk problems occur especially for RGBW, where white and colour interact with each other. The effect on white pixels depends on the nearby colour pixels. As a result, an artificial N×M pixel periodic grid-like structure on white pixels is visible.

U.S. Pat. No. 10,681,290 B1 discloses a method, an image sensor and an image processing device for crosstalk noise reduction. A raw image generated by a sensor array is obtained which comprises a plurality of image pixels and a plurality of phase detection pixels corresponding to a phase detection sensing element. The exposure and system gain of the image sensor, the pixel coordinates of the phase detection pixels and the sharpness information of the raw images is considered to determine whether to compensate image data of a current image pixel.

U.S. Pat. No. 8,947,563 B2 discloses a method for reducing video crosstalk in a display-camera system by capturing a first image of a local site while projecting an image of a remote site with a first gain and capturing a second image of the local site while projecting an image with a second gain that is different from the first gain. A mixed image of the local site is captured that includes the first image combined with the projected image having the first gain, and a second mixed image of the local site is captured that includes the second image combined with the projected image having second gain. Crosstalk reduction is performed on the mixed images to create a reconstructed image of the local site by determining whether a pixel value variation between the mixed images is affected by motion in the first and the second image of the local site.

U.S. Pat. No. 10,580,384 B1 discloses a method of calibrating a display panel, wherein crosstalk gain is calculated for a given value of the colour components using generated nonlinear models and the input value of a pixel. The crosstalk gain is applied to the colour components of a pixel to create crosstalk-compensated component values. The crosstalk gain calculation uses measurements of the panel to produce several electrical to optical transfer functions that are then compared to each other to produce gains that are applied to the output of the panel crosstalk model at the matrix multiply to produce an adjusted crosstalk corrected signal that the system uses to generate an overall gain to apply to the linear RGB input.

US 2021/0227185 A1 discloses a calibration circuit configured to receive digital image signal generated based on pixel signal output from a pixel array of an image sensor. A colour gain of the digital image signal is calculated based on a coefficient set calculated based on a reference image signal generated by a reference image sensor under a first light source having a first colour temperature. The colour gain is applied to the digital image signal to generate a calibrated image signal.

### SUMMARY OF THE INVENTION

The present invention provides an improved method and an image processing unit for processing image data provided by an image sensor.

In order to process image data comprising a frame formed by an array of pixels and to reduce the visual effect of pixel crosstalk caused by the colour filter array pattern, a grid-based gain is applied to the pixels of the frame. Each pixel value is multiplied by one of the different gain factors of a gain matrix providing a gain grid.

Reducing the crosstalk effect can be achieved by the steps of multiplying each pixel of the frame by a respective gain factor pre-defined in the stored gain matrix (i.e. the gain grid) in a pixel position which corresponds to the pixel in the frame when the gain matrix is positioned on the frame, wherein the gain matrix is smaller than the frame and is functionally (e.g. virtually or computationally/mathematically) placed in a plurality of different positions on the frame to multiply each pixel of the frame by a respective gain factor of the gain matrix.

Positioning the gain matrix on the pixel matrix of the frame provided by the image data of the image sensor is understood as a functional positioning to assign a pixel position in the frame to a respective pixel position in the gain matrix. It is not required to physically overlay or move the grid matrix over the pixel matrix of the frame. A virtual or computational assignment is sufficient and works the same as if the gain matrix would have been overlaid on the frame pixel matrix. This can be achieved by storing the gain matrix in a data storage and computing the multiply of a selected pixel value in the pixel position of the frame with a pre-selected stored gain factor of the gain matrix. The gain matrix can then be virtually repeated to cover all pixels of the frame by accessing the same gain factors in the gain matrix for a plurality of pixels in the pixel matrix of the frame, thus creating the effect as if the gain matrix were positioned over several sections of the frame to cover the whole frame.

By using different gain values for areas of the frame pixel array in the size of the gain matrix, crosstalk can be significantly reduced. In particular for white pixels, the gain factor can vary for white and surrounding colour pixels. This reduces the crosstalk effect between the white pixel value and the nearby pixel colour values.

The gain factors, which are assigned to the pixel positions of the gain matrix, can be calibrated on a flat-field reference image.

The size of the gain matrix can preferably be the size of the colour filter array pattern which is repeated to form the colour filter array in the size of the frame. Thus, the size of the gain matrix is determined by the size of the basic pattern of the colour filter array. This addresses the artificial periodic grid-like structure on white pixels occurring in the size of the basic colour filter array matrix due to the pixel crosstalk effect.

The N×M gain grid is periodic according to the N×M cells of the basic colour filter array pattern and the gain matrix is repeated over the size of the frame according to the colour filter array pattern.

The gain matrix can be repeatedly positioned on the frame in a periodical way so that the colour pattern of the frame matches the colour pattern assignment of the gain factors in the gain matrix. Each pixel can be multiplied on the frame by a respective gain factor of the periodically repeated gain matrix. Thus, the gain matrix is globally distributed over the frame and provides a gain factor pattern which is matched to the colour filter array pattern.

However, the crosstalk pattern can vary over the frame independently of the colour filter array pattern. Preferably, a set of different gain matrices is provided, wherein each gain matrix is assigned to a respective position of the gain matrix on the frame for multiplying each pixel of the frame by a respective gain factor in the pixel position in the overlaid related gain matrix.

Thus, different gain grids are used depending on the position in the frame to define a N×M gain grid not just globally, but also locally.

A selected gain matrix of the set of gain matrices can be allocated to a related support point in the frame. A support point that defines a support pixel position in the gain matrix matches a pixel position in the frame at a related support point defined for the frame in order to assign the gain factors in the pixel positions of the selected gain matrix to a respective pixel of the frame and to multiply the pixel value by a related gain factor.

Thus, a number of support points is defined in the frame, e.g. a set of U×V support points in the frame. These “macroscopic” support points are spread around the whole frame. Preferably, they are spread evenly around the whole frame. The set of gain matrices comprises angle points, i.e. support points of the gain grid, which are assigned to a respective support point in the related gain matrix when (functionally) placing the selected gain matrix over the frame. For each of the U×V support points, one selected N×M gain grid is assigned to place the selected gain grid over the frame in the position of the related support point.

The use of a plurality of support points and a plurality of gain matrices each comprising an individual set of gain factors for each pixel position in the gain matrix allows reducing crosstalk pattern, which varies over the frame.

One specific gain matrix can be provided for each support point in the frame.

Preferably, a gain matrix can be interpolated between adjacent gain matrices located at respective adjacent support points. Thus, the local gain grid is interpolated between the support points. As a result, to obtain gain factors for the whole pixel matrix of the frame, there is no need to place a gain matrix on every pixel of the frame. The gain factors for the pixel positions, where the different gain matrices at the support points do not cover these pixel positions, are determined by interpolating by the gain factors of the neighbouring gain matrices.

A set of different gain matrices can be provided, where each gain matrix is assigned to a respective colour. This allows a colour-adaptive gain grid to reduce pattern artefacts, which, for example, reappear on objects with saturated colours. The reason for such colour pattern artefacts is for example a white-colour interaction depending on the colour of the incident light.

The local colour can be determined for a matrix of pixels in the frame. The gain factors are determined for the pixel positions of said matrix of pixels in the frame with the set of different gain matrices based on the local colour determined for such a matrix of pixels in the frame.

Thus, instead of having a single set of gain matrices with related gain factors, multiple K sets of gain matrices are provided, where each set of gain matrices is calibrated for one specific colour.

The local colour can be determined by computing an average colour value of the primary colour pixels in a sliding-window local neighbourhood of the matrix of pixels in the location of the related gain matrix. The size of the matrix of pixels of the sliding window can be different from the size of the gain matrix. However, it is preferred that the size of the matrix of pixels of the sliding window is exactly the same as the N×M size of the gain matrix so that the measurement data does not already contain the very pattern the algorithm is supposed to compensate for. The average of the red, green and blue primary pixel colours in the sliding-window local neighbourhood of the N×M pixels of the colour matrix positions on the frame can be computed to determine the local colour.

The gain factors can be interpolated between the sets of gain matrices based on the determined local colour. This allows having a reduced number of multiple sets of gain matrices for a number of specific colours. The local colour, which does not match a specific colour of a pre-defined gain matrix, is addressed by interpolating the gain factors between at least two gain matrices of the set assigned to specific colours which are similar to the determined local colour. However, interpolation can also be performed based on more than two gain matrixes of the neighbouring colours.

Preferably, weights for the gain factors in the set of gain matrices are computed based on the respective local colour average value of the colour pixel values in the related matrix of pixels in the frame.

### BRIEF DESCRIPTION OF THE DRAWINGS

The invention is explained in more detail by way of exemplary embodiments with enclosed figures. These are:

FIG. 1—schematic block diagram of an image processor unit;

FIG. 2—example of a frame pixel array with a gain matrix positioned over the frame;

FIG. 3—example of a spatial interpolation of a frame comprising support points for positioning different gain matrices on the frame;

FIG. 4—example of a colour-adaptive interpolation of a frame with a set of gain matrices selected on a local colour.

### DETAILED DESCRIPTION OF THE INVENTION

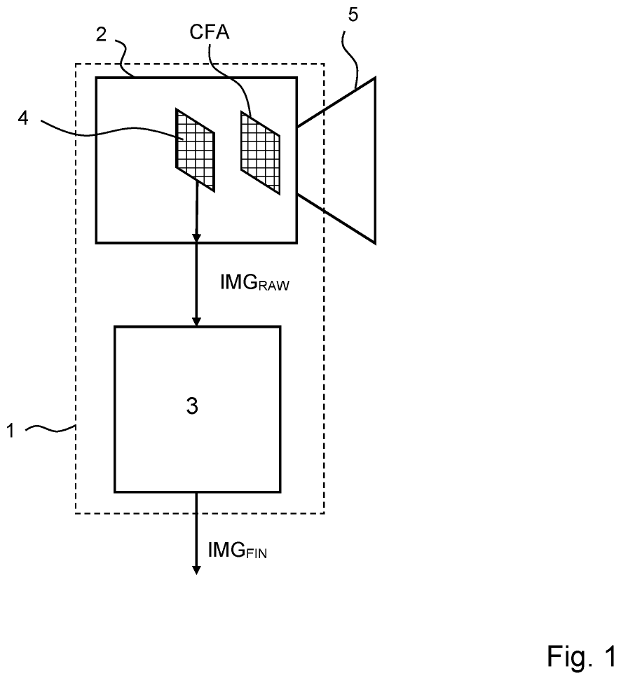

FIG. 1 presents an exemplary schematic blog diagram of an image processor unit 1 comprising a camera 2 and an image processor unit 3 for processing raw image data IMG RAW provided by an image sensor 4 of the camera 2.

The image sensor 4 comprises an array of pixels P_{x, y} so that the raw image IMG_{RAW} is the data set in a raw matrix of pixels per image. In order to capture colours in the image, a colour filter array CFA is provided in the optical path in front of the image sensor 4. The camera 2 comprises an opto-mechanical lens system 5, e.g. fixed uncontrolled lens. The image processor unit 1 can be incorporated in a handheld device like a smartphone, a tablet, wearables, a picture or a video camera or the like.

The image processor unit 3 is arranged to process image data IMG_{RAW} from the image sensor 4 capturing images, wherein a frame is also considered to be an image in the meaning of the present invention.

Advanced image sensors use complex colour filter array patterns. The most simple colour filter array pattern is the 2× Bayer colour filter array. However, larger N×M RGB or RGBW colour filter arrays (with R=red, G=green, B=blue, W=white) exist. For example, there are 4×4 Quad Bayer, 6×6 Nonacell, 2×2 RGBW Bayer colour filter array and 4×4 RGBW #1 Kodak colour filter array and the like.

There is the problem of pixel crosstalk between adjacent pixels, which is increased for larger colour filter array patterns, especially for colour filter array patterns including white pixels, where white and colour interact with each other. The effect on white pixels depends on the nearby colour pixels. Pixel crosstalk is a result of an artificial periodic grid-like structure in particular on white pixels with the size of N×M pixels of the colour filter array pattern.

To reduce the pixel crosstalk effect, a grid-based gain Wᵢ is applied to the pixel P_{x, y} of the raw image IMG_{RAW}.

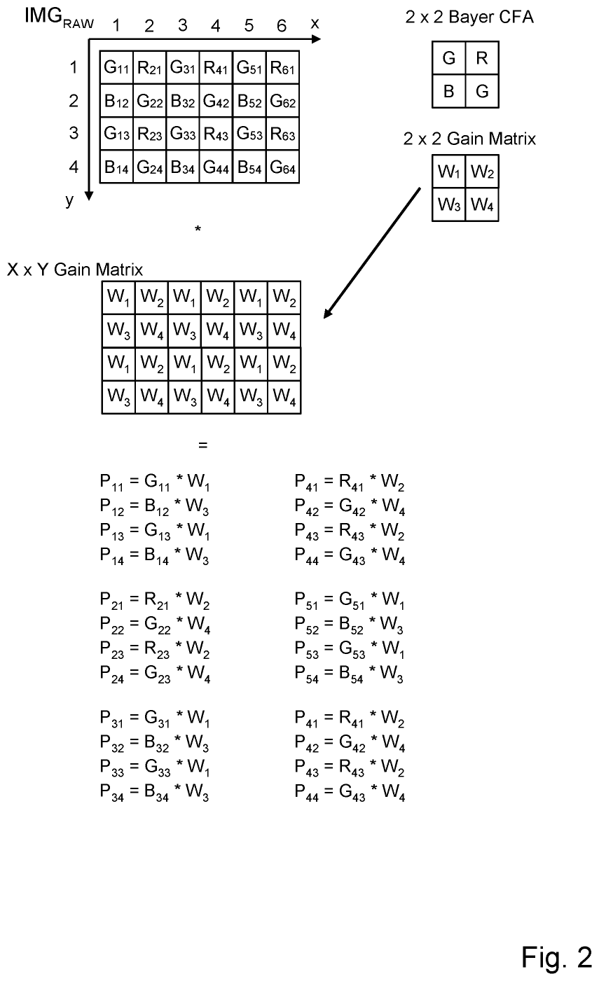

FIG. 2 is an example of a frame pixel array with a N×M grid matrix periodically positioned over the frame.

The image of frame comprises an array of pixels in the x, y position where each pixel is assigned to the respective colour of the colour filter array CFA. For easy understanding, the example is based on a 2×2 Bayer colour filter array comprising a 2×2 matrix including the pattern green-red-blue-green.

A respective N×M=2×2 gain matrix comprising the weights W₁, W₂, W₃ and W₄ for a respective pixel position in the gain matrix can be provided and stored in a data memory for this basic embodiment.

The image processor unit 3 can be arranged, e.g. by programming by a software or by a suitable hardware structure, to multiply each pixel P_{x, y} of the raw image data IMG_{RAW} by a respective weight Wᵢ of the N×M gain matrix as if the gain matrix were overlaid on the frame matrix shown in FIG. 2.

In the example of FIG. 2, the N×M=2×2 gain matrix is periodically repeated over the whole size of the frame matrix, e.g. 6×4 frame matrix as illustrated for the highly simplified example.

Each pixel P_{i, j} in a respective x, y position is multiplied by the respective weight Wₖ in the same x, y position. The result is a set of pixel values P_{i, j} for each y, x position processed by multiplying the pixel colour value in the pixel position by the related weight Wₖ.

The weights Wₖ of the N×M gain matrix can be calibrated on a flat-field reference image.

The use of N×M different gain values of a N×M gain matrix having the same size of the N×M colour filter array matrix reduces the artificial N×M pixel periodic grid-like structure caused by pixel crosstalk.

However, a crosstalk pattern can vary over the frame. This can be addressed by defining a N×M gain matrix (gain grid) not just globally as in FIG. 2. An improved embodiment provides different N×M gain matrices depending on the position in the frame.

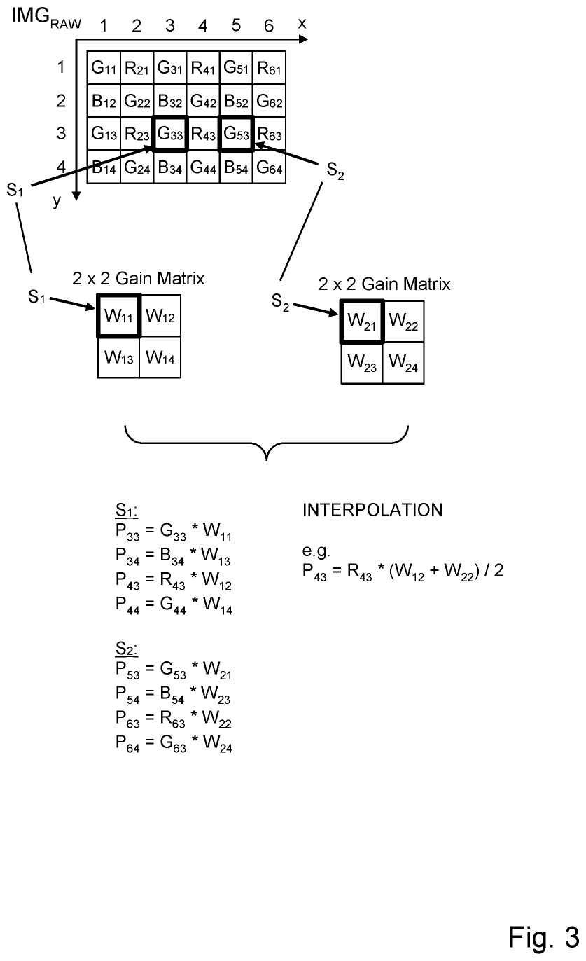

FIG. 3 presents an example of a spatial interpolation of a frame comprising support points Sₖ for positioning different gain matrices Sₖ on the frame.

In general, a number of U×V support points Sn can be defined in the frame, i.e. the raw image data IMG_{RAW}. Preferably, these support points Sn can be arranged in a grid at “macroscopic” pixel positions of the frame spread evenly around the whole frame. The number U×V can be a whole divisor of the size N×M of the gain grids in case that a uniform size N×M is used for the set of gain grids for a frame.

Based on the basic example in FIG. 2 with a simple 2×2 Bayer colour filter array, two exemplary support points S₁ and S₂ are shown in the frame of FIG. 3, i.e. the raw image data IMG RAW, to simplify the presentation.

There is a set of gain matrices Sₖ assigned to respective support points Sₖ. One gain matrix can be assigned to at least one support point Sₖ.

Preferably, there is one N×M gain matrix for each of the U×V support points Sₖ defined in the frame.

As illustrated, each of the support points Sₖ is assigned to a pixel position in a grid of the frame and in a grid of a related gain matrix. The “macroscopic” support points can spread evenly around the whole frame.

Each pixel value in the frame is related to a specific support point Sₖ and can then be weighted by the weight Wᵢ, j of the gain matrix related to the same support point Sₖ. This can be expressed e.g. by the formulas for a repeated 2×2 gain grid:
N×M=2×2 frame block for support point S₁:

$${P}_{33} = {G}_{33} * {W}_{11} \\ {P}_{34} = {G}_{34} * {W}_{13} \\ {P}_{43} = {G}_{43} * {W}_{12} \\ {P}_{44} = {G}_{44} * {W}_{14}$$

N×M=2×2 frame block for support point S₂:

$${P}_{53} = {G}_{53} * {W}_{21} \\ {P}_{54} = {G}_{54} * {W}_{23} \\ {P}_{63} = {G}_{63} * {W}_{22} \\ {P}_{64} = {G}_{64} * {W}_{24}$$

and so on.

In a further improved embodiment, the weights in the “local” gain matrix between the support points Sₖ can be interpolated by use of the weights Wᵢ in the neighbouring gain matrices which are aligned to the support points.

For example, this can be performed with the formulas by interpolating weights in neighbouring gain grids for the specific colour related to the pixel position:

$${P}_{33} = {G}_{33} * ( {W}_{11} + {W}_{21} ) / 2 \\ {P}_{34} = {G}_{34} * ( {W}_{13} + {W}_{23} ) / 2 \\ {P}_{43} = {G}_{43} * ( {W}_{12} + {W}_{22} ) / 2 \\ {P}_{44} = {G}_{44} * ( {W}_{14} + {W}_{24} ) / 2$$

and so on.

Pattern artefact caused by pixel crosstalk can also be affected by specific colours. A pattern can reappear on subjects with saturated colours, for example. The reason is that the interaction between white pixels and colour pixels depends on the colour of the incident light.

In order to further reduce all pattern artefacts, a colour-adaptive gain grid can be applied.

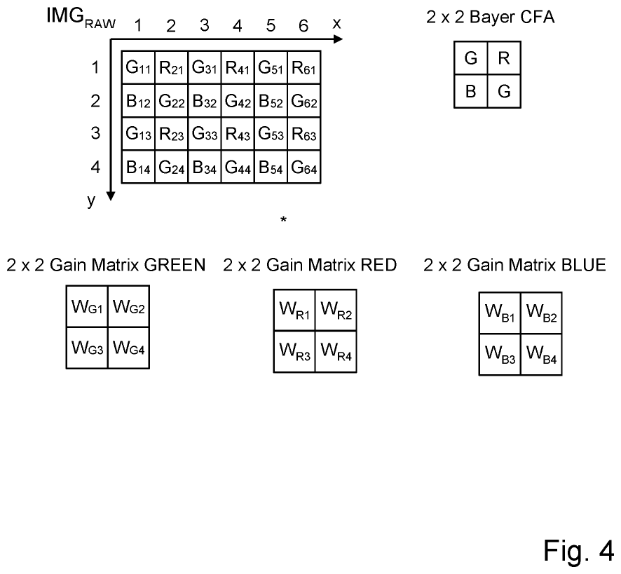

FIG. 4 presents a simplified example for a colour-adaptive interpolation of a frame with a set of gain matrices selected on a local colour.

Instead of having a single set of N×M gain matrices, or additionally, by use of support points Sₖ in N×M×U×V gain matrices, multiple sets of gain matrices assigned each to a specific colour can be provided. Each set of a gain matrix can be calibrated for one specific colour, i.e. R=red, G=green and B=blue.

The weights Wₖ for each pixel P_{i, j} can be interpolated between the K sets of gain matrices based on the local colour in the respective pixel position P_{i, j}.

The local colour of a pixel position P_{i, j} can be determined by computing an average of the R, G, B primary colour pixels in a sliding-window local neighbourhood of N×M pixels according to the N×M colour filter array and N×M gain matrix.

For example, weights Wᵢ for each of the K sets of the gain matrices can be computed based on the local RGB weights averages. The value K=3 can be selected for calibration for near-monochromatic Red (R), Green (G) and Blue (B) light.

The weights Wᵢ can be computed from the weights in the K sets, wherein each of the K sets of gain matrices is assigned to a specific colour. The weighting factors in the local gain matrix can be divided by the sum of the local RGB weighting factors in the matrices e.g. for the three colours green, red and blue according to the formula:

$${W}_{i} = {RGB}_{i} / sum ( RGB ) [ for i = 1 , 2 , 3 ] .$$

This results in the weight sum of 1.

Optionally, RGB white balance gains can be applied to local RGB averages.

According to a preferred embodiment of the present invention, exactly the N×M pixels, i.e. each pixel of the N×M pixel set, are used in the sliding-window local neighbourhood. Otherwise the measurement data would already contain the very pattern that the algorithm is supposed to compensate for.

In case that there are known defect pixels or PDAF pixels in the frame matrix, they should be ignored.

This is explained by use of the simple 2×2 Bayer colour filter array, a set of K=3 gain matrices which are defined and stored for local green, red and blue colour, and a simplified example for a possible routine for the colour-adaptive interpolation.

Each colour gain matrix comprises a set of N×M=2×2 weights W_{G1}, W_{G2}, W_{G3}, W_{G4} for the green matrix, W_{R1}, W_{R2}, W_{R3}, W_{R4} for the red gain matrix and W_{B1}, W_{B2}, W_{B3}, W_{B4} for the blue gain matrix. These weights W_{Rn}, W_{Gn} and W_{Bn} are also called Gain-Grids.

Further, average weights W_{R}, W_{G} and W_{B} can be determined by calculating these weights from the local RGB mean values.

The principle scheme is similar for higher order in N×M colour filter arrays and N×M gain matrices.

In addition, support points Sₖ can be defined in the frame matric IMG_{RAW} and the respective gain matrices as shown in FIG. 3. This leads to a set of gain matrices for each colour R, G and B.

The respective gain matrices are overlaid either periodically as shown in FIG. 2, or based on the support points Sₖ as shown in FIG. 3 on the frame matrix.

The pixel value P_{x, y} in the respective x, y position is calculated by the pixel value in the respective pixel position in the raw image data IMG_{RAW}, i.e. the frame matrix, and a computed weight Wᵢ.

The interpolated pixel values for the pixel positions can be calculated e.g. by the following simplified formulas:

$${P}_{11} = {G}_{11} * ( {W}_{R} * {W}_{R 1} + {W}_{G} * {W}_{G 1} + {W}_{B} * {W}_{B 1} ) \\ {P}_{12} = {B}_{12} * ( {W}_{R} * {W}_{R 3} + {W}_{G} * {W}_{G 3} + {W}_{B} * {W}_{B 3} ) \\ {P}_{21} = {R}_{21} * ( {W}_{R} * {W}_{R 2} + {W}_{G} * {W}_{G 2} + {W}_{B} * {W}_{B 2} ) \\ {P}_{22} = {G}_{22} * ( {W}_{R} * {W}_{R 4} + {W}_{G} * {W}_{G 4} + {W}_{B} * {W}_{B 4} ) \\ {P}_{31} = {G}_{31} * ( {W}_{R} * {W}_{R 1} + {W}_{G} * {W}_{G 1} + {W}_{B} * {W}_{B 1} ) \\ {P}_{32} = {B}_{32} * ( {W}_{R} * {W}_{R 3} + {W}_{G} * {W}_{G 3} + {W}_{B} * {W}_{B 3} ) \\ {P}_{41} = {R}_{41} * ( {W}_{R} * {W}_{R 2} + {W}_{G} * {W}_{G 2} + {W}_{B} * {W}_{B 2} ) \\ {P}_{42} = {G}_{42} * ( {W}_{R} * {W}_{R 4} + {W}_{G} * {W}_{G 4} + {W}_{B} * {W}_{B 4} ) \\ {P}_{13} = {G}_{13} * ( {W}_{R} * {W}_{R 1} + {W}_{G} * {W}_{G 1} + {W}_{B} * {W}_{B 1} ) \\ {P}_{14} = {B}_{14} * ( {W}_{R} * {W}_{R 3} + {W}_{G} * {W}_{G 3} + {W}_{B} * {W}_{B 3} ) \\ {P}_{23} = {R}_{23} * ( {W}_{R} * {W}_{R 2} + {W}_{G} * {W}_{G 2} + {W}_{B} * {W}_{B 2} ) \\ {P}_{24} = {G}_{24} * ( {W}_{R} * {W}_{R 4} + {W}_{G} * {W}_{G 4} + {W}_{B} * {W}_{B 4} )$$

and so on, in particular when W_{R}+W_{G}+W_{B}=1 is safeguarded. Otherwise, it is advisable to normalize the above formulas e.g. by dividing by the sum (W_{R}+W_{G}+W_{B}). This is exemplarily set out for the first pixel position and can be adapted accordingly for all pixel positions:

$${P}_{11} = {G}_{11} * ( {W}_{R} * {W}_{R 1} + {W}_{G} * {W}_{G 1} + {W}_{B} * {W}_{B 1} ) / ( {W}_{R} + {W}_{G} + {W}_{B} )$$

Further, it is an option to apply nonlinearity to the RGB averages. This leads to gain matrices defined in the perceptual colour space.

The saturation of local RGB averages can be increased as a further option in order to favour using pure gain grid sets of a mixing gains all the time.

If the sum of the R, B and G gain matrix sets is not equal to a gain matrix set calibrated for white light, the method might not work well enough for grey objects.

In particular, in this situation the method can be further improved by use of at least one of the strategies set out below.

Preferably, for colour filter arrays including white pixels, e.g. RGBW colour filter array, the weighting method explained above for RGB colour filter arrays can be supplemented.

An additional gain matrix or a set of gain matrices calibrated for white light is used. Thus, instead of K=3 RGB gain matrices as shown in FIG. 4, a set of K=4 gain matrices for the four “colours” red, green, blue, white is defined and stored in a data memory.

Saturation from local RGB averages is computed using a suitable metric. This can be simply computing the medium by determining the difference between the max (RGB)—min (RBG), i.e. the maximum value of the RGB pixel values. The suitable metric or colour representation model can be for example HSL (hue, saturation, lightness), HSV (hue, saturation, value), HSB (hue, saturation, brightness), or HSI (hue, saturation, intensity).

The saturation from local RGB averages can be computed by using a lookup into a two-dimensional lookup table LUT of saturation values. The two-dimensional correlates can be for example {R/(R+G+b), B/(R+G+B)}.

The two-dimensional lookup table LUT has the advantage of making the saturation dependent on hue so that a white grid works well for some colours.

The weights can be computed by use of a saturation factor sat as follows:

$${W}_{i} = sat * {RGB}_{i} / sum ( RGB ) [ for i = 1 , 2 , 3 ] \\ {W}_{4} = 1 - sat [ white channel ] .$$

The result is a weight sum of 1.

Optionally, the saturation value set can be modified, e.g. by applying an offset, a factor or an exponent, or some combination thereof. This has the effect of favouring the white set over saturated sets.

Alternative representations of the RGB colour model can be used by using representations including hues, i.e. the attribute of a visual sensation according to a vision area appears to be similar to one of the perceived colours, e.g. red, yellow, green and blue, or to a combination of two of them.

A set of K=N+1 gain matrices is defined and stored in a data memory with calibration for white and N different near-monochromatic hues.

RGB averages are transformed into a colour space comprising hue information, i.e. HSL, HSV, HSB or HIS. The information about lightness, value and intensity can be ignored.

Weights Wᵢ are computed for N hues. This can be performed e.g. by matching against the measured hue. Preferably, the Gaussian or the nearest neighbour or the like is determined to compute a weight Wᵢ for a measured hue.

It is also possible to use a two-dimensional lookup with N weight Wᵢ for each entry. The two-dimensional coordinates of the lookup table can be for example {R/(R+G+B), B/(R+G+B)}.

The weights Wᵢ are computed for neutral grey as Wᵢ=1−saturation.

The weights Wᵢ can be normalized so that the sum of the weights is 1.

Optionally, nonlinearities can be applied to hue and saturation.

1. A method for processing of image data provided by an image sensor, wherein the image data comprises a frame formed by an array of pixels, said pixel array being overlaid by a colour filter array so that the pixels represent colour information according to a specific colour pattern defined by the colour filter array, the method comprising:
multiplying each pixel of the frame by a respective gain factor pre-defined in a stored gain matrix for a pixel position which corresponds to the pixel in the frame when the gain matrix is positioned on the frame,
wherein the gain matrix is smaller than the frame and is placed in a plurality of different positions on the frame to multiply each pixel of the frame by a respective gain factor of the gain matrix.

2. The method according to claim 1, further comprising calibrating the gain factors assigned to the pixel positions of the gain grid on the flat-field reference image.

3. The method according to claim 1, wherein the size of the gain matrix is the size of the colour filter array pattern, which is repeated to form the colour filter array of the size of the frame.

4. The method according to claim 1, further comprising periodically repeated positioning of the gain matrix on the frame such that a colour pattern of the frame matches a colour pattern assigned to the gain factors in the gain matrix, and multiplying each pixel of the frame by a respective gain factor of the periodically repeated gain matrix.

5. The method according to claim 1, further comprising providing a set of different gain matrices, wherein each gain matrix is assigned to a respective position of the gain matrix on a frame for multiplying each pixel of the frame by a respective gain factor for the pixel position of the overlaid related gain matrix.

6. The method according to claim 5, further comprising allocating a selected gain matrix to a related support point in the frame, wherein a support point in a defined support pixel position of the selected gain matrix matches the pixel position of the support point in the frame in order to assign the gain factor for the pixel positions of the selected gain matrix to a respective pixel of the frame and to multiply the pixel value by the related gain factor.

7. The method according to claim 6, further comprising providing one specific gain matrix for each support point in the frame.

8. The method according to claim 6, further comprising interpolating a gain matrix between adjacent gain matrices located on respective adjacent support points.

9. The method according to claim 1, further comprising
providing a set of different gain matrices, wherein each gain matrix is assigned to a respective colour,
determining a local colour for a matrix of pixels in the frame, and
determining the gain factors for the pixel positions of said matrix of pixels in the frame with the sets of different gain matrices based on the determined local colour for said matrix of pixels.

10. The method according to claim 9, further comprising determining the local colour by computing an average colour value of the primary colour pixels in a sliding-window local neighbourhood of the matrix of pixels in the location of the related gain matrix, wherein the size of the matrix of pixels is the size of the gain matrix.

11. The method according to claim 9, further comprising interpolating the gain factors between the sets of gain matrices based on the determined local colour.

12. The method according to claim 9, further comprising computing weights for the gain factors in the set of gain matrices based on the respective local colour average values of the colour pixel values in the related matrix of pixels in the frame.

13. An image processor unit for processing image data provided by an image sensor, said image sensor comprising a sensor pixel array providing a frame formed by an array of pixels being overlaid by a colour filter array so that the pixels represent colour information according to a specific colour pattern defined by the colour filter array, wherein the image processor unit is configured to
multiply each pixel of the frame by a respective gain factor defined in the stored gain matrix in the pixel position which corresponds to the pixel in the frame when the gain matrices are positioned on the frame,
wherein the gain matrix is smaller than the frame and is placed on a plurality of different positions on the frame to multiply each pixel of the frame by the respective gain factor of the gain matrix.

14. The image processor unit according to claim 13, wherein the image processor unit is configured to process image data by performing the method steps of claim 1.

15. A computer program embodied on a non-transitory computer-readable medium, the computer program comprising instructions which, when the computer program is executed by a processing unit, causes the processing unit to carry out the steps of the method of claim 1.
